(19) United States
(12) Patent Application Publication
(10) Pub. No.: US 2007/0226001 A1
(43) Pub. Date: Sep. 27, 2007

(54) Method for conserving real property resources

(76) Inventors: Luis Noel de Pau Hoyos, Alvaro Obregon (MX); Jose A. de Pau Hoyos, Alvaro Obregon (MX); Mariana de Pau Hoyos, Alvaro Obregon (MX); Victor Can Echeverria, Cancun (MX); Stuart E. Iddles, Cancun (MX); Marcos N. Zuniga Cendejas, J. Del Sur (MX); Ruben Bello Rivera, J. Del Sur (MX); Maria Pedrero Corzo, Chiapas (MX); Antonio D. Martinez Lopez, Chiapas (MX); Patricia Ensnarriaga Hermosillo, Del Carmen Coyoacan (MX); Rene F. Chan Pavon, Col. (MX)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/708,032

(22) Filed: Feb. 20, 2007

Related U.S. Application Data
(60) Provisional application No. 60/775,681, filed on Feb. 22, 2006.

(51) Int. Cl. G06Q 10/00; G06Q 30/00

(52) U.S. Cl. 705/1

(57) ABSTRACT

A method for preserving real property for conservation including presenting to potential customers a selection of real property for conservation; accepting a customer selection of the real property for consideration; conducting an aspect of another transaction via a network; and applying money associated from another transaction to a conservative-based transaction related to the selected real property.

### FIELD OF THE INVENTION

The invention relates generally to the field of operating a business and more particularly to operating a business in a manner that will promote the conservation of valuable resources such as real property resources.

### BACKGROUND OF THE INVENTION

The loss of valuable resources is a problem that eludes an easy solution. For decades, the loss of rain forest, particularly in South America, has received substantial publicity. It's widely accepted that the Amazon rain forest is critical to the earth's oxygen supply. Depletion of the rain forest, and, in fact, deforestation worldwide, is a large contributor to the problem of global warming. In addition to global warming, deforestation results in the loss of critical habitat for many of the earth's animals and other organisms.

Notwithstanding widespread appreciation for the devastating impact of deforestation here and throughout the world, most people do little, if anything, to address the problem. For some, it is simply a lack of knowledge of what to do. For others, there is the belief that one person cannot make an impact without a substantial contribution of money or time. And for still others, there is a lack of trust that any contributions will actually be used to address the root of the problem.

Even before the emergence of the internet for commercial purposes, there has been attempts to adapt the travel business to the widespread recognition that people are negatively impacting our ecology. “Ecotourism” is term of relatively recent vintage and signifies the travel industry's response to the problem discussed above. Generally, ecotourism attempts to attract visitors to areas of the world by advertising that their visit will not negatively impact the environment. In addition, the tour companies conducting such ecotours will attempt to educate the visitors to the importance of preserving our natural resources.

Likewise, without regard to e-commerce, sellers have used charitable donations to distinguish buyers and attract buyers. The “Newman's Own” line of products is illustrative: these products have advertised to the effect that profits are donated to charities. Another is “Yo Baby” yogurt, which also advertises that a percentage of the purchase price is donated to charity. In neither case, however, is the buyer permitted any role in selecting how the money will be used by the charity, nor is the user provided any feedback which would show the impact of the donation.

Since the widespread emergence of e-commerce here and throughout the world, there have been attempts to use e-commerce to divert money to charities. Typically, members of a particularly charity or group are given the option to contribute some portion of a purchase price to the charity the shopper belongs to. The facilitator of the donation receives a fee for directing the shopper to a particular commercial site. The shopper may later receive a record of the charitable donations.

### SUMMARY OF THE INVENTION

A method for doing business according to the principles of the invention uses a portion of money exchanged in a commercial transaction to conserve a natural resource. In one aspect of the invention, the resource is real property. Conservation of the real property can be, for example, purchase of the property, purchase of a conservation easement on the property, purchase of development rights on the property, or purchase of any property interest that will tend to conserve the property.

In one embodiment of the invention, the method is implemented in an e-commerce solution. Just for example and not by way of limitation, the business can be a travel agency booking travel domestically and abroad. For each transaction, the traveler can select real property for conservation. Theoretically, the real property selected by the traveler can be anywhere in the world. Alternatively, the traveler can permit the travel agency to select the property for conservation.

In another aspect of the invention, the buyer can view and select from various real properties for conservation. In still another aspect, when the conserving transaction is concluded, the buyer can view evidence of the conversation. One such way for viewing evidence of the transaction would be to give the buyer access to the recorded deed, easement or the like which evinces the conserving transaction. In another aspect of the invention, the contributions of like-minded buyers are pooled to purchase the conservation right.

In these and other aspects of the invention, e-commerce sites are improved to present the ability to select property or other resources, initiate the conserving transaction, and permit the tracking of attributes of the conserving transaction so that the buyer experiences a direct feedback of the charitable contribution. Aspects of the invention may include distinct networks for implementing the conserving transaction. Such networks need not be limited to machine implemented networks, and may specifically include persons for carrying out the conserving transactions either in the United States or abroad.

An exemplary transaction according to the principles of the invention may proceed as follows: A potential consumer accesses an e-commerce site capable of initiating a conservation transaction or of directing the consumer to a separate site having the capacity to initiate a conservation transaction. The user proceeds to initiate the primary commercial transaction, which can be, for example, booking travel plane via a travel services site. As a result of this session the consumer is advised that a portion of the purchase price can be used to conserve some potentially important resource. The consumer is directed to an interface that permits the user to select the resource to be conserved. Once selected, the processes required to conserve the resource are initiated. This may involve pooling of the consumer's predetermined contribution with other contributions, purchasing a conserving right in the resource, and then recording documentary evidence of the conserving transaction. Optionally, the conserved resource right may be obtained in the name of the consumer, either independently or jointly with other contributors.

### BRIEF DESCRIPTION OF THE DRAWINGS

In the drawings:

FIG. 1 depicts an exemplary network for implementing the method of the invention;

FIG. 2 depicts an exemplary system for implementing an aspect of the invention; and

FIG. 3 shows an exemplary interface.

### DETAILED DESCRIPTION

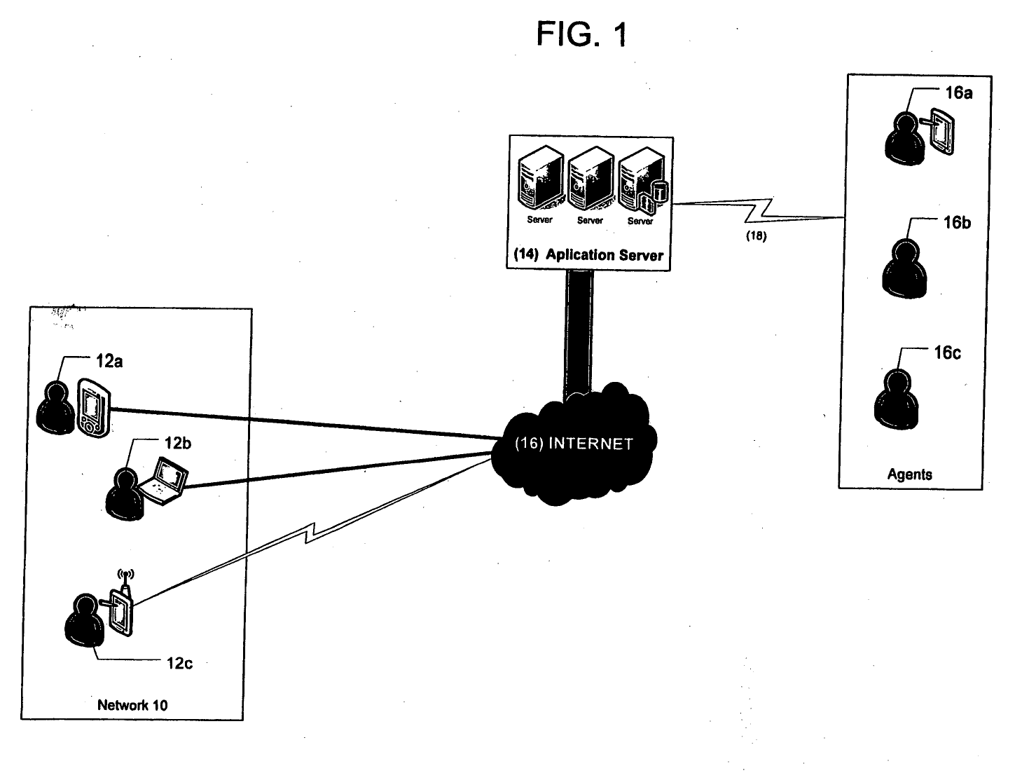

FIG. 1 shows an exemplary network 10 for implementing the method of the invention. The network 10 includes users 12a, 12b and so on, communicating with a computer system 14. The communication link is shown over a network cloud 16, and in this implementation contemplates implementation over the world wide web. The users 12a, 12b and so on, access the web using personal computers or other machines capable of communication over the web. The computer system 14 is preferably one or more computers or computer servers implementing software intended to carry out the method of the invention as more specifically specified hereafter. The computers implement an interface for the users such that the users can carry out or cause transactions according to the principles of the invention. In this embodiment, the servers are in communication with agents 16a, 16b, 16c and so on. These agents represent persons, machines or a combination of persons or machines for carrying out aspects of the invention. And although the computer system 14 is shown in communication with the agents via the arrow 18, such communication arrow is merely representative. Communication with the agents can be direct or indirect, over networks or the like. All that is contemplated is that the commands given by users 12a, 12b and so on are translated into transactions carried out whole or in part via the agents.

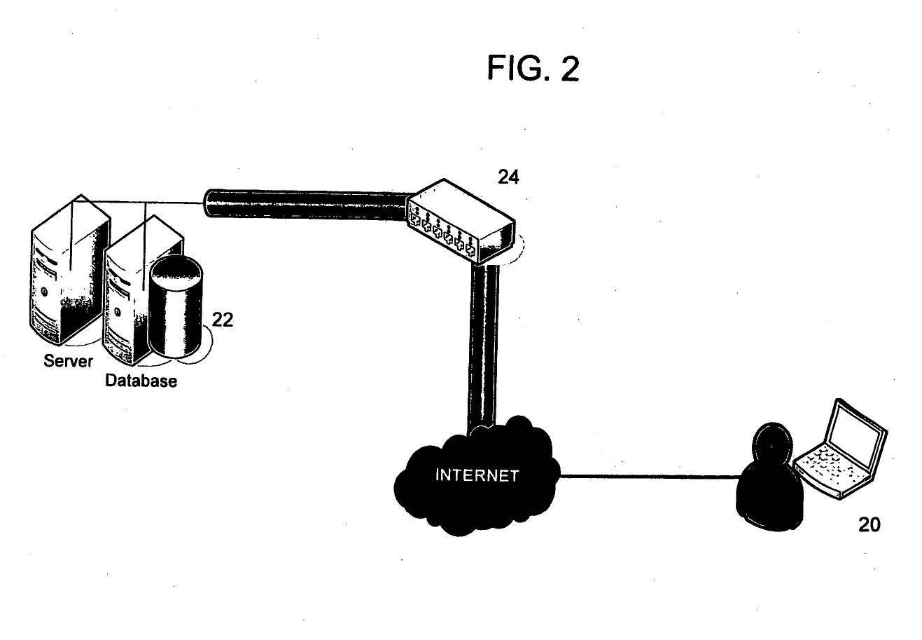

FIG. 2 depicts with more particularity the functions of the computer system 14. There is shown an interface 20, a database 22 and a communications module 24. The interface 20 represents the interface provided to the users when a session is initiated. In this sense, the interface permits the user to select a tour, conduct business with e-commerce site, view properly virtually, and select properties for investment. In the exemplary embodiment, the interface permits communication with the e-commerce site as is typically known in the art. The database 22 is an exemplary relational database for storing business transaction information, including information related to the desired real property transaction. In an exemplary transaction, therefore, a user accesses an e-commerce site via the world wide web and is presented an interface for interaction with the site. During a visit to the site, the user can access information concerning particular travel tours of this like, perform travel planning, view property for conservation and anything else required to carry the method of the invention.

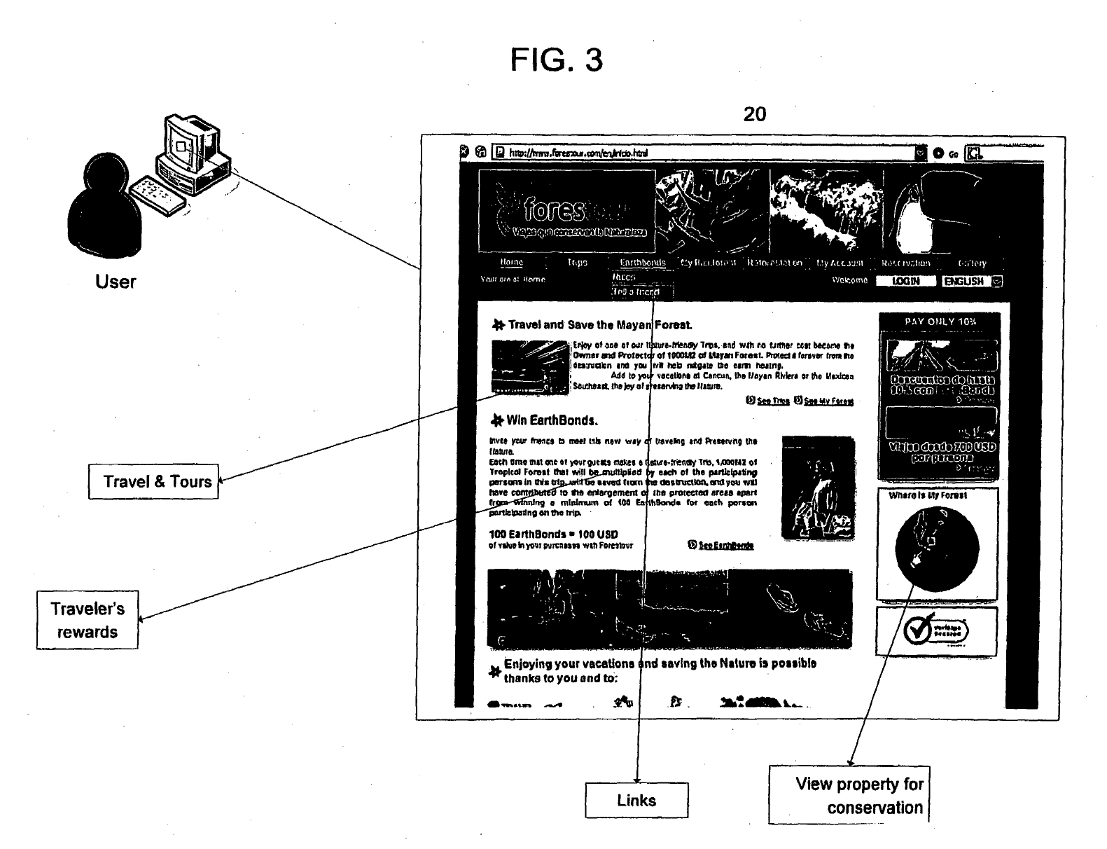

Referring to FIG. 3, for purposes of this exemplary embodiment, the user interface 20 is a web-based interface including links, controls or other objects for initiating and conducting transactions with e-commerce system. For example, an interface can include one or more objects for carrying out the travel related transaction, one of which objects initiates the transaction when activated by the user. In this sense, the object when activated can cause the placing of a travel reservation. The interface can also include objects which when activated causes the display of information related to the property for conservation. This can include an object or objects which when activated cause a virtual tour of such property. Also, an object or objects are contemplated for initiating the conservation transaction, which can include causing the purchase of shares or ownership interest in an entity having previously purchased the property for conservation.

The interface includes an object or objects which when activated cause the user to send invitations to other people to visit the site. Rewards may be given to those users that are the first ones in sending the invitations or whose invitation was the first accepted.

In one embodiment, the property for conservation is owned by an entity such as corporation or association. The entity is structured such that there are a limited number of shares, and preferably the shares are proportional to the acreage owned by the entity. For example, a 10,000 acre parcel can be owned by an entity having 10,000 shares. The entity acts as the agent to cause the conservation transaction for the property, which transactions can take place before customers transact for travel related services. In this embodiment, the putative customer visits the e-commerce site to arrange for travel. During the visit, the user may view virtually property for conservation, including property owned by the entity. If the user elects to travel, the user then selects the property for conservation. In response to the request and the travel related transaction, the entity causes the user to become an owner in the entity, and thus an owner of the conserved property. The user is provided either electronically or in hard copy papers evincing the user's ownership interest in the entity, as well as documentation demonstrating that the entity has implemented a conservation transaction, such as a deed restriction, for the conserved property.

There would be other ways to implement the method of the invention, including conducting the conservation transaction after the user commits to travel related services. These alternatives are considered to embody the method of the invention. Likewise, the system of the invention is not limited to a web based network. Dedicated networks, telephone networks, private networks and the like can be used to carry-out the method of the invention.

We claim:

1. A method for operating a travel tour business comprising the steps of:
accepting a travel reservation form a customer; and
in connection with the travel reservation, conducting a real property transaction.

2. The method of claim 1 further comprising the step of advertising a real property transaction in connection with accepting a travel reservation.

3. The method of claim 1 further comprising the step of presenting a selection of real property for the real property transaction, and selecting the real property for the transaction.

4. The method of claim 1 wherein the real property comprises a natural resource.

5. The method of claim 1 wherein the transaction is selected from the group consisting of a transfer of legal title, the transfer of development rights, or the transfer of an easement.

6. The method of claim 1 comprising the further step of notifying a party to the transaction of the completion of the transaction.

7. The method of claim 1 wherein the real property is owned by a non-human entity.

8. A networked based method for preserving real property in a natural state comprising the steps of:
presenting to potential customers a selection of real property for conservation;
accepting a customer selection of the real property for conservation;
conducting an aspect of another transaction via the network; and
applying money associated from the another transaction to a conservation-based transaction related to the selected real property.

9. The network based method of claim 8 wherein the conservation-based transaction comprises obtaining legal title to real property comprising the selected real property.
